(19) United States
(12) Patent Application Publication
(10) Pub. No.: US 2007/0085362 A1
(43) Pub. Date: Apr. 19, 2007

(54) Operation means box device

(75) Inventor: Minoru Sato, Mooka-shi (JP)

Correspondence Address: WENDEROTH, LIND & PONACK, L.L.P., 2033 K STREET N. W., SUITE 800, WASHINGTON, DC, 20006-1021, US

(73) Assignee: KOMATSU LTD., Tokyo (JP)

(21) Appl. No.: 10/572,686

(22) PCT Filed: Jul. 8, 2005
(86) PCT No.: PCT/JP05/12675

§ 371 Date: Mar. 20, 2006

(30) Foreign Application Priority Data
Jul. 20, 2004 (JP) 2004-210883

(51) Int. Cl. B60R 27/00

(52) U.S. Cl. 296/24.34

(57) ABSTRACT

An operation means box device that is disposed on the side of an operator seat; in which an operation means box that has operation means on the upper surface is freely movably installed in the front-rear direction relative to the operator seat; and which comprises locking means for fixing the operation box at a prescribed position, that can minimize the operator's fatigue in operating the operation means provided in the operation means box, in which an unlocking handle for unlocking the locking means is disposed in a location other than the upper surface of the operation means box.

### TECHNICAL FIELD

The present invention relates to an operation means box device in, for example, a piece of construction equipment, or the like, and particularly to an operation means box device that is disposed on a side of an operator seat; in which an operation means box that has operation means on an upper surface is freely movably installed in a forward-rearward direction; and which comprises locking means for fixing the operation means box at a prescribed position.

### BACKGROUND ART

For example, in a wheel loader or other construction equipment that is provided with a side console (operation means box) being placed on the side of an operator seat and having an operation lever for operational machine or for steering or the like, the front part of the side console, operation lever or the like is protruded from the operator seat and occupies a part of the boarding gate in the operator cab. Then, in order to eliminate this problem, an operation means box device in which the position of the side console is rendered variable has been provided (for example, the patent literature 1 referenced).

With a conventional operation means box device A as shown in FIG. 8, an operation lever (operation means) M is vertically disposed in the front part (the left area in the figure) of a lever stand (operation means box) B; on the operator cab floor F, a guide member G is extendingly provided in the front-rear direction of the vehicle; and a slider S disposed inside the lever stand B is slidably engaged with the above-mentioned guide member G, whereby the above-mentioned lever stand B is slidably held between the forward position, which is protruded toward the boarding space of the operator cab (not shown), and the rearward position, which is withdrawn from the boarding space.

In addition, a handle H for sliding is mounted on the upper surface of the above-mentioned lever stand B, and a lever L which upper end is protruded to above the upper surface of the lever stand B is supported freely movably in the vertical direction inside the above-mentioned lever stand B, and the lever L is biased downward by a spring V.

On the other hand, an engagement plate R provided with two engagement holes Ra, Rb is fixedly installed on the upper surface of the floor F, and the lower end of the lever L is selectively engaged in the above-mentioned respective holes Ra, Rb when the lever stand B is in the forward position or the rearward position.

When an operator is to get down from the operator cab (not shown), the operator pulls up the lever L of the lever stand B placed in the forward position (the solid line position in the figure) in the upward direction in order to unplug the lower end of the lever L from the engagement hole Ra in the engagement plate R, and then grips the handle H for sliding to slide the lever stand B to the rearward position (the two-dash line position in the figure).

Then, by releasing the hand from the lever L, the lower end of the lever L is engaged with the engagement hole Rb in the engagement plate R by the biasing force of the spring V, the above-mentioned lever stand B being fixed in the rearward position, whereby the interference of the lever stand B and the operation lever M with the boarding gate is minimized, resulting in the operator getting in and out being rendered extremely easy.

Patent literature 1: Japanese Patent Application Laid-open No. S63-210317

### DISCLOSURE OF THE INVENTION

Problems to be Solved by the Invention

By the way, with the conventional operation means box device A as described above, the handle H for sliding and the upper end of the lever L are protruded above the upper surface of the lever stand B, thus there has been a problem that, in operating the operation lever M, the operator cannot put the elbow on the upper surface of the lever stand B, and particularly, when operating the operation lever M over a long period of time, the operator gets fatigue.

In view of the above-mentioned situation, the purpose of the present invention is to provide an operation means box device that can minimize the operator's fatigue when the operation means provided in the operation means box is operated.

Means to Solve the Problems

In order to achieve the above-mentioned purpose, an operation means box device pertaining to claim 1 provides an operation means box device that is disposed on a side of an operator seat; in which operation means box that has operation means on an upper surface is freely movably installed in a forward-rearward direction; and which comprises locking means for fixing the operation means box at a prescribed position,

wherein an unlocking handle for an unlocking operation of the locking means is disposed on a surface of the operation means box other than the upper surface thereof.

In addition, the invention pertaining to claim 2 provides the operation means box device according to claim 1, wherein a fixed handle faces against the unlocking handle is fixedly installed to the operation means box.

In addition, the invention pertaining to claim 3 provides the operation means box device according to claim 2, wherein the fixed handle is fixedly installed in a region above the unlocking handle that can be moved in a vertical direction.

In addition, the invention pertaining to claim 4 provides the operation means box device according to claim 2, wherein the fixed handle, together with the unlocking handle, is disposed on an outside surface of the operation means box.

In addition, the invention pertaining to claim 5 provides the operation means box device according to claim 1, wherein the locking means comprises;

an engaging member that is fixedly installed to a support that freely movably supports the operation means box,

a locking member that is installed in the operation means box, and is engaged with and disengaged from the engaging member,

a biasing member that biases the locking member to engage with the engaging member, and

a rocking lever that has the unlocking handle at one end, and is pivotally by the operation means box to enable the locking member to be moved for operation.

In addition, the invention pertaining to claim 6 provides the operation means box device according to claim 5, wherein a fixed handle that faces against the unlocking handle is fixedly installed to the operation means box.

In addition, the invention pertaining to claim 7 provides the operation means box device according to claim 6, wherein the fixed handle is fixedly installed in a region above the unlocking handle that can be moved in a vertical direction.

In addition, the invention pertaining to claim 8 provides the operation means box device according to claim 6, wherein the fixed handle, together with the unlocking handle, is disposed on an outside surface of the operation means box.

Effects of the Invention

According to the operation means box device pertaining to the invention of claim 1, the unlocking handle is disposed in a location other than the upper surface of the operation means box, whereby the operator can put the elbow on the upper surface of the operation means box without being obstructed by the unlocking handle, and particularly, even when the operation means is to be operated over a long period of time, the operator can put the elbow on the upper surface of the operation means box, thereby greatly alleviating the fatigue. Additionally, because the unlocking handle is disposed in the operation means box which is placed on the side of the operator seat, the operator can easily operate the unlocking handle, and move the operation means box, while seating on the operator seat.

According to the operation means box device pertaining to the invention of claim 2, in addition to the effects by the invention of claim 1, the fixed handle is provided as facing against the unlocking handle. Thus, in operating the unlocking handle, the operator simultaneously grips the fixed handle, which makes possible to prevent the operation means box from being subjected to an inadvertent force along the direction of operating the unlocking handle.

According to the operation means box device pertaining to the invention of claim 3, in addition to the effects by the invention of claim 1, the fixed handle is provided in the region above the unlocking handle that can be moved in the vertical direction. Thus, in operating the unlocking handle, the operator simultaneously grips the fixed handle, which allows preventing the operation means box from being subjected to an inadvertent force along the direction of operating the unlocking handle. Additionally, by holding out the hand from above and engaging the thumb with the fixed handle, the operator can operate the unlocking handle in a posture that is reasonable from the viewpoint of ergonomics.

According to the operation means box device pertaining to the invention of claim 4, in addition to the effects by the invention of claim 1, the unlocking handle and the fixed handle are located in the outer side surface of the operation means box. Thus, the above-mentioned fixed handle can be effectively utilized as an assist grip when the operator gets on the operator cab from the outside.

According to the operation means box device pertaining to the invention of claim 5, in addition to the effects by the invention of claim 1, the locking means is comprised of the engaging member, the locking member, the biasing member, and the rocking lever, whereby the unlocking handle can be disposed in a location other than the upper surface of the operation means box in a simplest possible configuration.

According to the operation means box device pertaining to the invention of claim 6, in addition to the effects by the invention of claim 5, the fixed handle is provided as facing against to the unlocking handle. Thus, in operating the unlocking handle, the operator simultaneously grips the fixed handle, which makes possible to prevent the operation means box from being subjected to an inadvertent force along the direction of operating the unlocking handle.

According to the operation means box device pertaining to the invention of claim 7, in addition to the effects by the invention of claim 5, the fixed handle is provided in the region above the unlocking handle that can be moved in the vertical direction. Thus, in operating the unlocking handle, the operator simultaneously grips the fixed handle, which makes possible to prevent the operation means box from being subjected to an inadvertent force along the direction of operating the unlocking handle. In addition, by holding out the hand from above and engaging the thumb with the fixed handle, the operator can operate the unlocking handle in a posture which is reasonable from the viewpoint of ergonomics.

According to the operation means box device pertaining to the invention of claim 8, in addition to the effects by the invention of claim 5, the unlocking handle and the fixed handle are disposed in the outer side surface of the operation means box. Thus, the above-mentioned fixed handle can be effectively utilized as an assist grip when the operator gets on the operator cab from the outside.

### BRIEF DESCRIPTION OF THE DRAWINGS

FIG. 1 is an appearance of side view from the left side of the operator cab of a piece of construction equipment to which an operation means box device pertaining to the present invention is applied;

FIG. 2 is a side view from the left side showing one embodiment of the operation means box device pertaining to the present invention, including an operator seat;

FIG. 3 is a plan view from above showing one embodiment of the operation means box device pertaining to the present invention, including the operator seat;

FIG. 4 is a sectional view taken along the line IV-IV of FIG. 2 from the direction of the arrows;

FIG. 5 is a sectional view taken along the line V-V of FIG. 3 from the direction of the arrows;

FIG. 6 is a critical portion sectional view illustrating another embodiment of the operation means box device pertaining to the present invention;

FIG. 7 is a critical portion sectional view illustrating still another embodiment of the operation means box device pertaining to the present invention; and

FIG. 8 is a side view conceptually illustrating a conventional operation means box device.

### EXPLANATION OF REFERENCE NUMERALS

1: Operation means box device
2: Stand (support element)
3: Side console (operation means box)
3s: Outer side surface
3t: Top surface
4: Operation lever (operation means)
5: Guard
6: Unlocking handle
6L: Rocking lever
7: Fixed handle
10: Locking means
11: Locking plate (engaging member)
12: Locking pin (locking member)
13: Compression spring (biasing member)
100: Construction equipment
101: Operator cab
102: Floor
103: Operator seat

### BEST MODE FOR CARRYING OUT THE INVENTION

Hereinbelow, the configuration of an operation means box device pertaining to the present invention will be described with reference to the drawings illustrating embodiments.

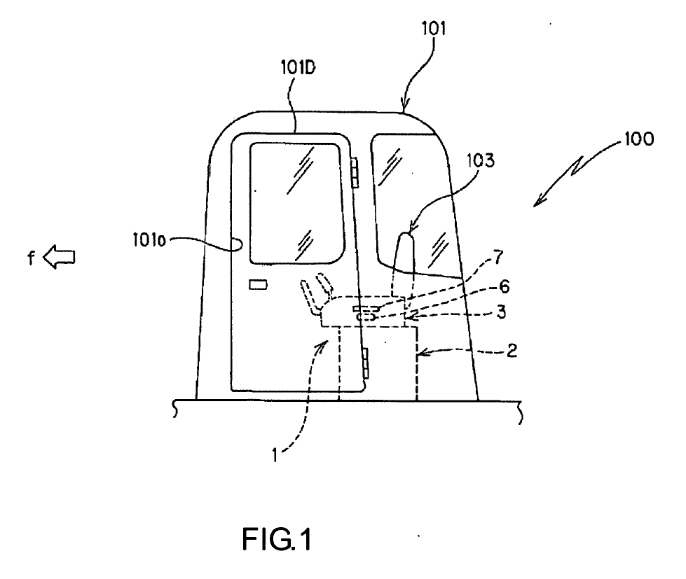

FIG. 1 to FIG. 5 show an example of application of the present invention to the operation means box device in a piece of construction equipment, such as a wheel loader, or the like. As shown in FIG. 1 to FIG. 3, an operator seat 103 is installed on a floor 102 inside an operator cab 101 in a piece of construction equipment 100, and an operation means box device 1 (later described) is installed on the left side with respect to the operator seat 103, i.e., in the side where a door 101D for the operator cab 101 is provided. By the way, in FIG. 1 to FIG. 3, an arrow f indicates the front of the vehicle in the piece of construction equipment 100.

The operation means box device 1 comprises a stand (support element) 2 which is vertically disposed on the floor 102 of the operator cab 101, and a side console (operation means box) 3 which is installed on the top part of the stand 2.

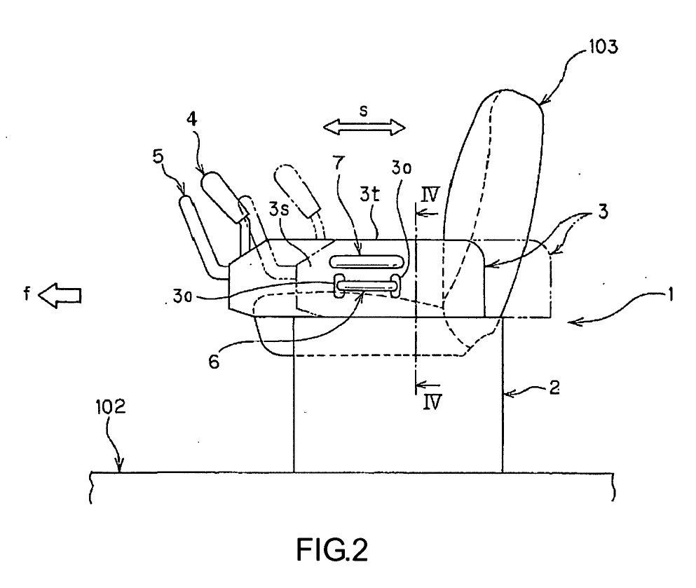

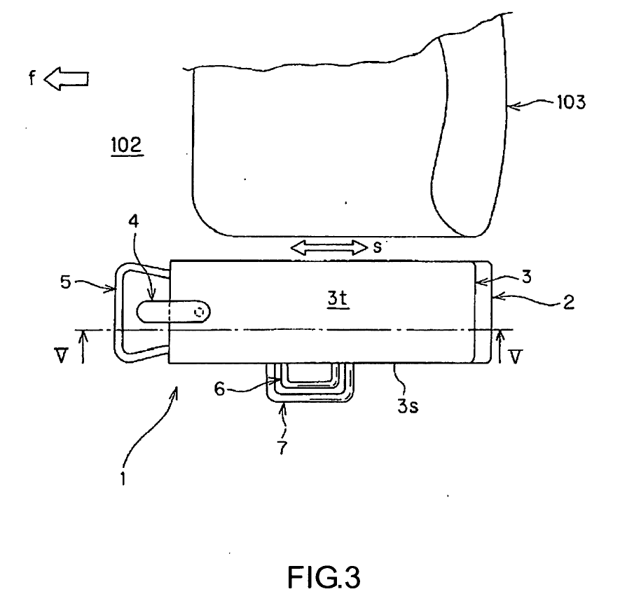

The above-mentioned side console 3 is freely movable along the front-rear direction of the vehicle in the piece of construction equipment 100, in other words, the front-rear direction of the operator seat 103, as shown with an arrow s in FIG. 2 and FIG. 3, being slided between the forward position, which is more protruded than the front end of the operator seat 103 (the solid line position in FIG. 2), and the rearward position, which is more withdrawn than the front end of the operator seat 103 (the dot-dash line position in FIG. 2).

In the front part of the side console 3, an operation lever (operation means) 4, such as an electric steering lever (with which a switch provided on a knob allows speed change, and forward or rearward motion selection operation), or the like, is installed, being protruded upward from the above-mentioned side console 3. In addition, in the front part of the side console 3, a guard 5 which prevents the operator from contacting with the operation lever 4 when getting in and out of the operator cab 101 is provided so as to cover the front of the above-mentioned operation lever 4.

In addition, on the left side of the above-mentioned side console 3, i.e., in the outer side surface 3s of the side console 3 that faces away from the operator seat 103 (faces the vehicle outside), an unlocking handle 6 for causing locking means 10 (later described) to make an unlocking operation is installed.

The above-mentioned unlocking handle 6 is formed in the plane view shape of a letter pi, protruding from the above-mentioned outer side surface 3s toward the left side of the vehicle (toward the bottom in FIG. 3) through holes 3o, which is formed in the outer side surface 3s of the side console 3.

Further, in the outer side surface 3s of the side console 3, a fixed handle 7 is fixedly installed above the unlocking handle 6, facing against the unlocking handle 6, and this fixed handle 7 is formed in the plan view shape of a letter pi, protruding from the above-mentioned outer side surface 3s toward the left side of the vehicle (toward the bottom in FIG. 3).

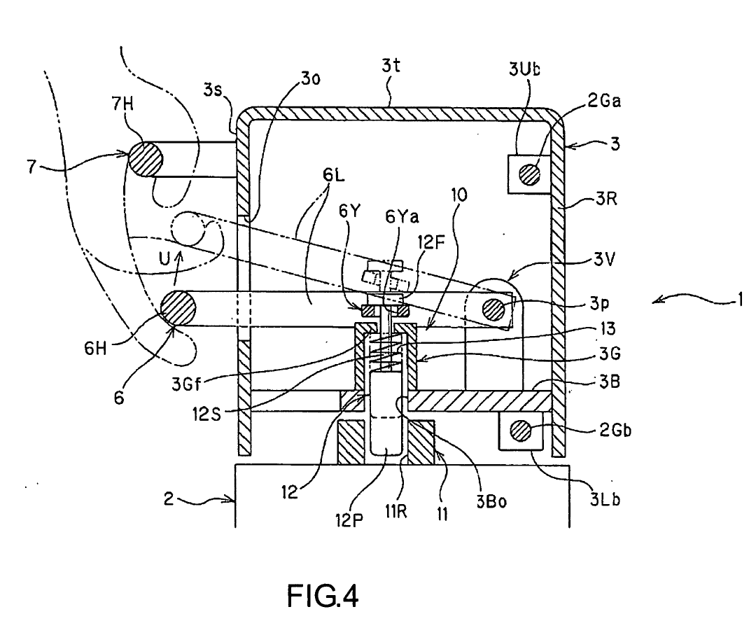

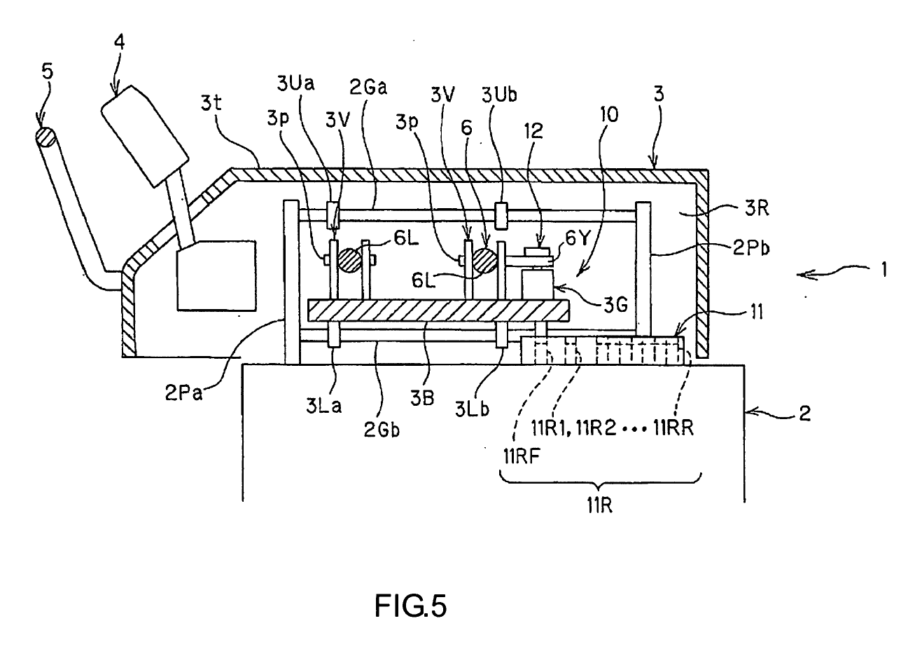

As shown in FIG. 4 and FIG. 5, on the upper surface of the stand 2 constituting the operation means box device 1, a pair of plates 2Pa, 2Pb are vertically disposed, being separated from each other in the front-rear direction of the vehicle (the left-right direction in FIG. 5), and between these plates 2Pa, 2Pb, two guide rails 2Ga, 2Gb which are vertically separated from each other, being in parallel to each other, are provided.

On the other hand, inside the right side plate 3R of the side console 3, a pair of upper supports 3Ua, 3Ub supported by the above-mentioned guide rail 2Ga, and a pair of lower supports 3La, 3Lb supported by the above-mentioned guide rail 2Gb are fixedly installed, whereby the above-mentioned side console 3 is slided, being guided by the guide rail 2Ga, 2Gb in the front-rear direction of the vehicle.

In addition, on the upper surface of the stand 2 constituting the operation means box device 1, a locking plate 11 is fixedly installed as an engaging member constituting the locking means 10, and in this locking plate 11, a plurality of locking holes 11R which are sunk in the vertical direction are arranged and formed along the front-rear direction of the vehicle, in other words, the sliding direction of the side console 3.

The above-mentioned locking hole 11R comprises a locking hole 11RF for locking the side console 3 in the forward position; a locking hole 11RR for locking it in the rearward position; and locking holes 11R1, 11R2, 11R3 for adjusting the front-rear position that are provided therebetween. In the locking plate 11, the engaging part may be made up of grooves or protrusions, instead of the locking holes which are sunk in the vertical direction.

On the other hand, a base 3B disposed inside the bottom of the side console 3 is provided with a locking pin 12 as a locking member which is engaged with and disengaged from the above-mentioned locking plate 11, and this locking pin 12 comprises a plunger 12P which is fitted into the locking hole 11R in the locking plate 11; a shaft 12S which is screwed into the top part of the plunger 12P; and a flange 12F which is formed in the top part of the shaft 12S.

In addition, the above-mentioned locking pin 12 is provided freely movably along the vertical direction with the plunger 12P being penetrated through a pin hole 3Bo in the base 3B, and the plunger 12P being accommodated in the guide sleeve 3G of the base 3B, and is biased toward the bottom in order to engage the above-mentioned plunger 12P with the locking hole 11R in the locking plate 11 by a compression spring 13 as a biasing member that is disposed between the upper surface of the above-mentioned plunger 12P and the flange part 3Gf of the guide sleeve 3G.

The end of rocking levers 6L, 6L which are provided by extending the two parallel arms of the above-mentioned unlocking handle 6, are connected to a pair of brackets 3V, 3V which are fixedly disposed on the upper surface of the base 3 placed inside the side console 3, through pivot pins 3p, 3p which each provide rotating fulcrum. And the unlocking handle 6 is moved along the vertical direction by causing the above-mentioned rocking lever 6L to be pivoted around the above-mentioned pivot pins 3p, 3p.

In addition, the above-mentioned rocking lever 6L is provided with a yoke 6Y that faces the top part of the locking pin 12, and the shaft 12S of the locking pin 12 is inserted into a notch 6Ya formed in this yoke 6Y. The flange 12F of the locking pin 12 is butted against the upper surface of the yoke 6Y, and by causing the rocking lever 6L to be pivoted upward, the above-mentioned locking pin 12 is moved upward against the biasing force of the compression spring 13.

Now, when the operator sitting on the operator seat 103 opens the door 101D of the operator cab 101 from the inside thereof, and get out to the outside, passing through the boarding gate 101o, the operator first holds out the hand toward the side console 3 locked in the forward position from above; engages the thumb with the grip 7H of the fixed handle 7, and engages the other fingers with the grip 6H of the unlocking handle 6; grips the unlocking handle 6 together with the fixed handle 7; and pulls up the above-mentioned unlocking handle 6 as shown with an arrow U in FIG. 4 in order to cause the rocking lever 6L to be pivoted from the position indicated with a solid line to that indicated with a dot-dash line.

As described above, by causing the rocking lever 6L to be pivoted, the locking pin 12 of which flange 12F is engaged with the yoke 6Y is pulled up against the biasing force of the compression spring 13, and the plunger 12P of the above-mentioned locking pin 12 is unplugged from the locking hole 11RF of the locking plate 11, whereby the side console 3 is released from the locked state with respect to the stand 2.

Then, while gripping the fixed handle 7 and the unlocking handle 6, the operator draws the hand rearward in order to slide the side console 3 to the rearward position, and then releases the hand from the unlocking handle 6, which lowers the unlocking handle 6 and the rocking lever 6L to the position indicated with a solid line, with the locking pin 12 being lowered by the elastic returning force of the compression spring 13.

With the locking pin 12 being lowered, the plunger 12P of the locking pin 12 is fitted into the locking hole 11RR in the locking plate 11, whereby the side console 3 is locked in the rearward position, the front part of the side console 3 being withdrawn from the boarding gate 101o, which allows the operator to easily get off, passing through the boarding gate 101o.

On the other hand, by the operator getting on from the outside of the operator cab 101, and sitting on the operator seat; then operating the unlocking handle 6 to release the side console 3 from the locked state; and then sliding the side console 3 forward, and fitting the plunger 12P of the locking pin 12 into an appropriate locking hole 11R of the plurality of locking holes 11R (11R1, 11R2, 11R3, . . . ) in the locking plate 11, the operator can lock the side console 3 in any position where the operation lever 4 can be easily operated.

According to the operation means box device 1 configured as described above, the unlocking handle 6 is disposed on the outer side surface 3s of the side console 3, in other words, in a location other than the upper surface 3t, whereby the operator can put the elbow on the upper surface 3t of the side console 3 without being obstructed by the unlocking handle 6, and particularly, even in such a case as when the operation lever 4 is to be operated over a long period of time, the operator can put the elbow on the upper surface 3t of the side console 3, thereby greatly alleviating the fatigue.

In addition, because the unlocking handle 6 is disposed on the side console 3 which is disposed on the side of the operator seat 103, the operator can easily operate the unlocking handle 6, and move the side console 3, while sitting on the operator seat.

In addition, because the unlocking handle 6 and the fixed handle 7 are located in the outer side surface 3s of the side console 3, in other words, in the outer side surface 3s which faces away from the operator seat 103 (faces the vehicle outside), they will not obstruct the operator who sits on the above-mentioned operator seat 103.

In addition, the unlocking handle 6 and the fixed handle 7 are disposed in the outer side surface 3s of the side console 3, thus the above-mentioned fixed handle 7 can be effectively utilized as an assist grip when the operator gets on the operator cab 101 from the outside, or gets down from the operator cab 101, which renders getting in and out of the operator cab 101 extremely easy.

In addition, the fixed handle 7 is provided in the region above the unlocking handle 8 facing against it, thus in operating the unlocking handle 6, the operator simultaneously grips the fixed handle 7, which allows preventing the side console 3 from being subjected to an inadvertent force occurred in the direction of operating the unlocking handle 6, i.e., that of bringing the side console 3 upward, and thus allows the side console 3 to be slided smoothly.

In addition, the fixed handle 7 is provided in the region above the unlocking handle 6, thus by holding out the hand from above and engaging the thumb with the fixed handle 7, the operator can operate the unlocking handle 6 in a posture which is reasonable from the viewpoint of ergonomics.

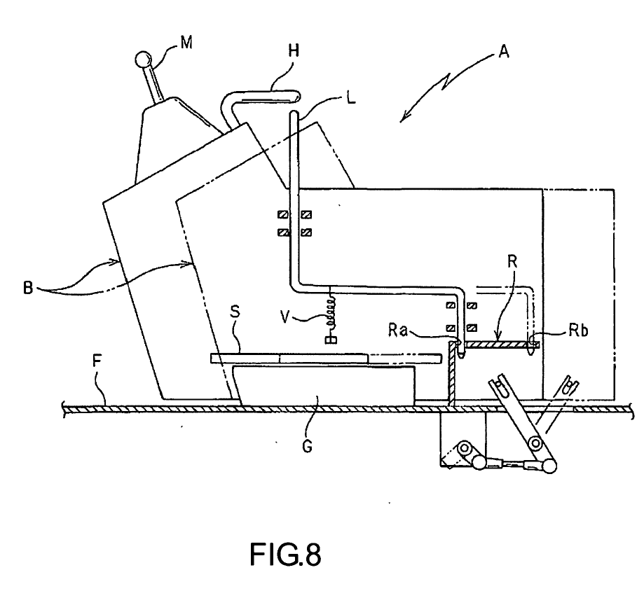

Further, the locking means 10 is composed of the locking plate 11, the locking pin 12, the compression spring 13, the rocking lever 6L, and the like, whereby the unlocking handle 6 can be disposed in a location other than the upper surface 3t of the side console 3 in a simplest possible configuration, as compared to the conventional operation means box device in which the unlocking lever is installed in the upper surface of the side console (see FIG. 8).

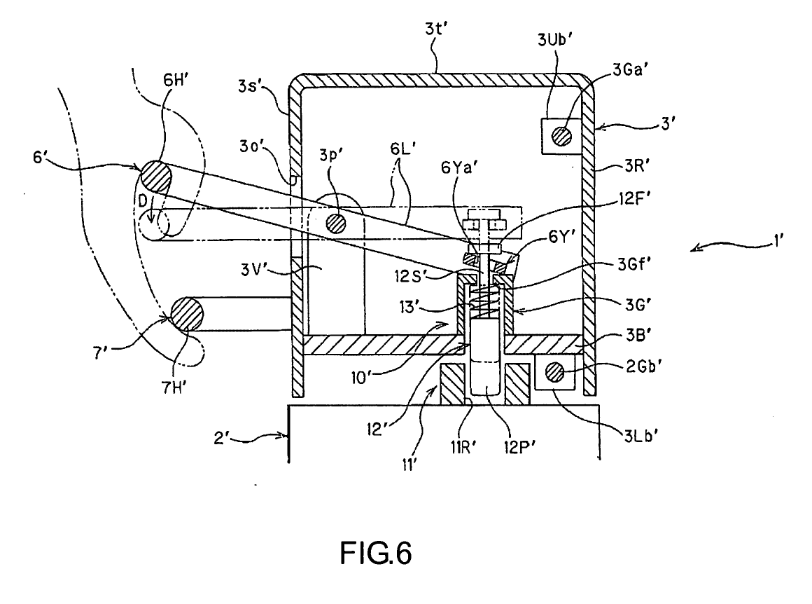

With the operation means box device 1′ as shown in FIG. 6, the central portion of the rocking lever 6L′ which is provided by extending the unlocking handle 6′ is pivotally supported by the bracket 3V′ fixedly installed on the base 3B′ through the pivot pin 3p′, and the locking pin 12′ is engaged with the yoke 6Y′ provided in the end part of the above-mentioned rocking lever 6′.

In addition, in the outer side surface 3s′ of the side console 3′ from which the unlocking handle 6′ is protruded, the fixed handle 7′ is fixedly installed in the region under the above-mentioned unlocking handle 6′, and by gripping the above-mentioned unlocking handle 6′ together with the fixed handle 7′, and causing the rocking lever 6L′ to be pivoted downward as shown with an arrow D, the above-mentioned locking pin 12′ is moved upward against the biasing force of the compression spring 13′, and the plunger 12P′ is unplugged from the locking plate 11′, whereby the side console 3′ is released from the locked state with respect to the stand 2′.

The configuration of the operation means box device 1′ as described above is basically the same as that of the operation means box device 1 as shown in FIG. 1 to FIG. 5, other than the operation direction for the unlocking handle 6′ and the layout of the fixed handle 7′ with respect to the unlocking handle 6′, thus for the components of the operation means box device 1′ that provide the same functions as those of the operation means box device 1, the same signs in FIG. 6 as those in FIG. 4 are provided with a prime mark, and detailed description is omitted.

Also with the operation means box device 1′ configured as described above, the unlocking handle 6′ is disposed in the outer side surface 3s′ of the side console 3′, thus the operator can put the elbow on the upper surface 3t′, thereby the operator's fatigue can be greatly alleviated, and, of course, for the other points, the same advantageous effects as those of the operation means box device 1 as shown in FIG. 1 to FIG. 5 are provided.

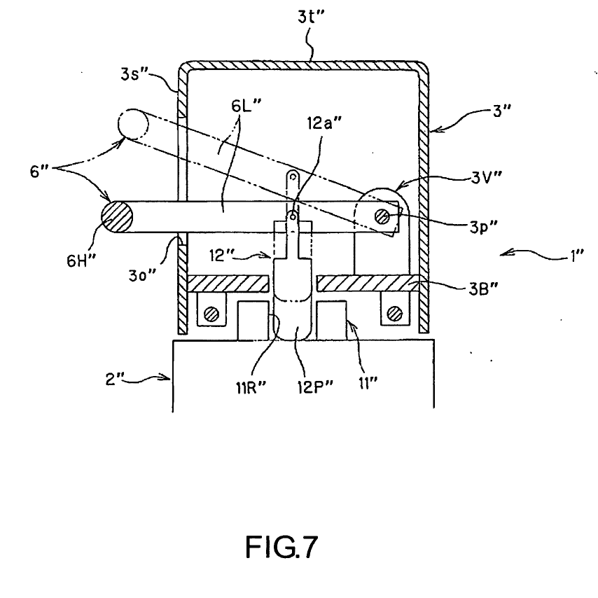

With the operation means box device 1″ as shown in FIG. 7, a locking pin 12″ is freely rockably pivoted by a pin 12a″ in the central portion of the rocking lever 6L″ which is provided by extending the unlocking handle 6″, and when the operator moves the unlocking handle 6″ upward, the locking pin 12″ is moved upward with the rocking lever 6L″ being pivoted, and the plunger 12P″ is unplugged from the locking plate 11″, resulting in the side console 3″ being released from the locked state with respect to the stand 2″.

On the other hand, when the operator releases the hand grip from the raised unlocking handle 6″, the above-mentioned locking pin 12″ is lowered by the weight of the unlocking handle 6″ and rocking lever 6L″ as a biasing member, and the plunger 12P″ is fitted into the locking plate 11″, whereby the side console 3″ is locked with respect to the stand 2″.

The configuration of the operation means box device 1″ as described above is basically the same as that of the operation means box device 1 as shown in FIG. 1 to FIG. 5, other than the configuration in which the weight of the unlocking handle 6″ and rocking lever 6L″ is utilized as a biasing member, and that in which no fixed handle is provided, thus for the components of the operation means box device 1″ that provide the same functions as those of the operation means box device 1, the same signs in FIG. 7 as those in FIG. 4 are provided with a double prime mark, and detailed description is omitted.

Also with the operation means box device 1″ configured as described above, the unlocking handle 6″ is disposed in the outer side surface 3s″ of the side console 3″, thus the operator's fatigue can be greatly alleviated, and, of course, for the other points, the same advantageous effects as those of the operation means box device 1 as shown in FIG. 1 to FIG. 5 are provided.

Herein, in the respective embodiments as described above, the unlocking handle and the fixed handle are provided in the outer side surface of the side console, however, they may be installed in any appropriate portion other than the upper surface of the side console, for example, the front surface or the rear surface, and further, the inner side surface, or the like, according to the various requirements, such as the specifications for a piece of construction equipment, and the like.

In addition, in the respective embodiments as described above, the unlocking handle is formed in the shape of a letter pi, however, it may be in the shape of, for example, a letter L, a letter T, a bar, or a plate, and when such a shape is adopted, the number of rocking levers extending from the unlocking handle being only one will not, of course, impair the function of the unlocking handle.

In addition, in the respective embodiments as described above, the fixed handle is formed in the shape of a letter pi as with the unlocking handle, however, it may be in the shape of, for example, a letter L, a letter T, a bar, or a plate, and further, a configuration in which the fixed handle is excluded, being not installed, may be adopted as required.

In addition, in the respective embodiments as described above, an operation means box device in which an operation lever is installed in the upper surface of the side console is disclosed. However, of course, the present invention may also effectively be applied to operation means box devices with which various types of operation means, such as operation pushbutton, operation key, touch panel, and the like in place of the above-mentioned operation lever.

In addition, in the respective embodiments as described above, locking means made up of a combination of an engaging member, a locking member, a biasing member and a rocking lever is adopted, however, of course, locking means having any construction other than that in the embodiments may be the construction adopted, provided that the unlocking operation is performed by the unlocking handle installed in some location other than the upper surface of the side console.

Further, in the respective embodiments as described above, an example of application of the present invention to the operation means box device in a piece of construction equipment, such as a wheel loader, or the like, is given. However, of course, the present invention is also effectively applicable to various pieces of construction equipment other than the wheel loader, and further to various machines and vehicles other than the construction equipment, provided that they are equipped with an operation means box device that is disposed on the side of an operator seat; in which an operation means box that has operation means on an upper surface is freely movably installed in a forward-rearward; and which comprises locking means for fixing the operation box at a prescribed position.

1. An operation means box device that is disposed by a side of an operator seat; in which an operation means box that has operation means on an upper surface is freely movably installed in a forward-rearward direction relative to the operator seat; and which comprises locking means for fixing the operation means box at a prescribed position,
wherein an unlocking handle for unlocking the locking means is provided on a surface of the operation means box other than the upper surface thereof.

2. The operation means box device according to claim 1, wherein a fixed handle that faces against the unlocking handle is fixedly installed to the operation means box.

3. The operation means box device according to claim 2, wherein the fixed handle is fixedly installed in a region above the unlocking handle that can be moved in a vertical direction.

4. The operation means box device according to claim 2, wherein the fixed handle is disposed on an outside surface of the operation means box together with the unlocking handle.

5. The operation means box device according to claim 1, wherein the locking means comprises;
an engaging member that is fixedly installed to a support that freely movably supports the operation means box,
a locking member that is installed in the operation means box, and is engaged with and disengaged from the engaging member,
a biasing member that biases the locking member to engage it with the engaging member, and
a rocking lever that has the unlocking handle at one end, and is pivotally supported in the operation means box to enable the locking member to be moved and operated.

6. The operation means box device according to claim 5, wherein a fixed handle that faces against the unlocking handle is fixedly installed to the operation means box.

7. The operation means box device according to claim 6, wherein the fixed handle is fixedly installed in a region above the unlocking handle that can be moved in a vertical direction.

8. The operation means box device according to claim 6, wherein the fixed handle is disposed on an outside surface of the operation means box together with the unlocking handle.
